(19) United States
(12) Patent Application Publication
(10) Pub. No.: US 2008/0075034 A1
(43) Pub. Date: Mar. 27, 2008

(54) Wireless communication method, wireless bridge device and wireless communication system

(75) Inventor: Yuan-Te Hsieh, Tainan County (TW)

Correspondence Address: BIRCH STEWART KOLASCH & BIRCH, PO BOX 747, FALLS CHURCH, VA, 22040-0747, US

(73) Assignee: Arcadyan Technology Corporation

(21) Appl. No.: 11/525,176

(22) Filed: Sep. 22, 2006

(51) Int. Cl. H04Q 7/00; H04L 12/56

(52) U.S. Cl. 370/328; 370/400

(57) ABSTRACT

A wireless communication method applies a wireless bridge device cooperating with a first electronic device and a second electronic device. The wireless communication method includes the steps of: scanning service set identifiers of the wireless bridge device and the second electronic device by the first electronic device; detecting signal intensity emitted by the wireless bridge device and the second electronic device by the first electronic device; wirelessly communicating with the first electronic device in a first wireless communication mode by the wireless bridge device; and wirelessly communicating with the second electronic device in a second wireless communication mode by the wireless bridge device. A wireless bridge device and a wireless communication system are also disclosed.

### BACKGROUND OF THE INVENTION

1. Field of Invention

The invention relates to a wireless communication method, a wireless bridge device and a wireless communication system, and, in particular, to a wireless communication method, a wireless bridge device and a wireless communication system capable of enlarging the communication range and integrating different wireless communication modes.

2. Related Art

In the information exploding age, information transmission has become an indispensable portion in the daily life, and the information transmission mainly can be achieved by the wired network and wireless communication. The wireless communication has become an important issue in the modern technology due to the savings of the cost and time in disposing the network cable and the overstepping of the ground obstructer. Institute of Electrical and Electronics Engineers (IEEE) defines two communication modes including a peer-to-peer mode (Ad hoc) and an access point mode (Infrastructure) in the specification of wireless communication 802.11. Generally speaking, communications between multiple terminal apparatuses (e.g., a computer) are made by an access point (AP) in the access point mode, while communications between multiple terminal apparatuses (e.g., a computer) are made directly without the access point in the peer-to-peer mode.

FIG. 1 is a schematic illustration showing wireless communication performed in a conventional access point mode. A wireless bridge device (e.g., a wireless access point) 11 and electronic devices (e.g., notebook computers each having wireless Ethernet adapter) 12 and 13 establish a wireless local network. A wireless bridge device 14 and electronic devices 15 and 16 establish another wireless local network. Each wireless local network pertains to the type of star topology. These two wireless local networks interconnect and communicate with each other through the wireless bridge devices 11 and 14.

FIG. 2 is a schematic illustration showing wireless communication performed in a conventional peer-to-peer mode. Three electronic devices (e.g., notebook computers) 21, 22 and 23 each having a wireless Ethernet adapter can interconnect and communicate with one another without the access point. In this case, the service set identifiers (SSID) and channels of the wireless Ethernet adapters of the electronic devices 21, 22 and 23 are set to be the same. Thus, the electronic devices 21, 22 and 23 can interconnect and communicate with each other.

The communication under the peer-to-peer mode does not need any access point and the wireless local area network can be quickly established. However, each electronic device has a maximum communication distance, such as several tens of meters, indoors because the communication range of the wireless Ethernet adapter is limited, and the communication with other electronic devices, which are out of the range of the communication distance of the electronic device, cannot be established. In addition, because the three electronic devices 21, 22 and 23 communicate with one another in the peer-to-peer mode, they cannot communicate with the electronic device operated in the access point mode.

In addition, the wireless home technology is developed rapidly. In the application of the wireless home theater apparatus, it is troublesome to the consumers and the manufacturers due to the too-long distance between the speaker and the amplifier or other hosts, which disables the wireless home theaters from being connected to each other or one another.

Consequently, it is an important subject of the invention to provide a wireless communication method, a wireless bridge device and a wireless communication system, which can lengthen the communication distance of the electronic device in the peer-to-peer mode and make the electronic devices interconnect and communicate with one another in the access point mode.

### SUMMARY OF THE INVENTION

In view of the foregoing, the invention is to provide a wireless communication method, a wireless bridge device and a wireless communication system capable of lengthening a communication distance and enabling electronic devices working in two different wireless communication modes to communicate with each other.

To achieve the above, the invention discloses a wireless communication method applying a wireless bridge device cooperating with a first electronic device and a second electronic device. The wireless communication method includes the steps of: scanning service set identifiers of the wireless bridge device and the second electronic device by the first electronic device; detecting signal intensity emitted by the wireless bridge device and the second electronic device by the first electronic device; wirelessly communicating with the first electronic device in a first wireless communication mode by the wireless bridge device; and wirelessly communicating with the second electronic device in a second wireless communication mode by the wireless bridge device.

To achieve the above, the invention also discloses a wireless bridge device including a first wireless-communication-mode processing module, a second wireless-communication-mode processing module and an integration interface module. The first wireless-communication-mode processing module receives and transmits a first wireless-communication-mode signal in a first wireless communication mode. The second wireless-communication-mode processing module receives and transmits a second wireless-communication-mode signal in a second wireless communication mode. The integration interface module transforms the first wireless-communication -mode signal into the second wireless-communication-mode signal and transforms the second wireless-communication-mode signal into the first wireless-communication -mode signal.

To achieve the above, the invention also discloses a wireless communication system including a wireless bridge device, a first electronic device and a second electronic device. The first electronic device wirelessly communicates with the wireless bridge device in a first wireless communication mode. The second electronic device wirelessly communicates with the wireless bridge device in a second wireless communication mode.

In the wireless bridge device, the wireless communication system and the wireless communication method of the invention, the wireless bridge device may serve as a repeater device to lengthen the communication distance of the electronic device when the electronic devices perform the communication with the same mode (e.g., the peer-to-peer mode). When the electronic devices perform the communication with different wireless communication modes, the wireless bridge device transforms the signals with different wireless communication modes to serve as a communication bridge for the electronic devices such that the information can be transmitted between the electronic devices.

### BRIEF DESCRIPTION OF THE DRAWINGS

The invention will become more fully understood from the detailed description given herein below illustration only, and thus is not limitative of the present invention, and wherein:

FIG. 1 is a schematic illustration showing wireless communication performed in a conventional access point mode;

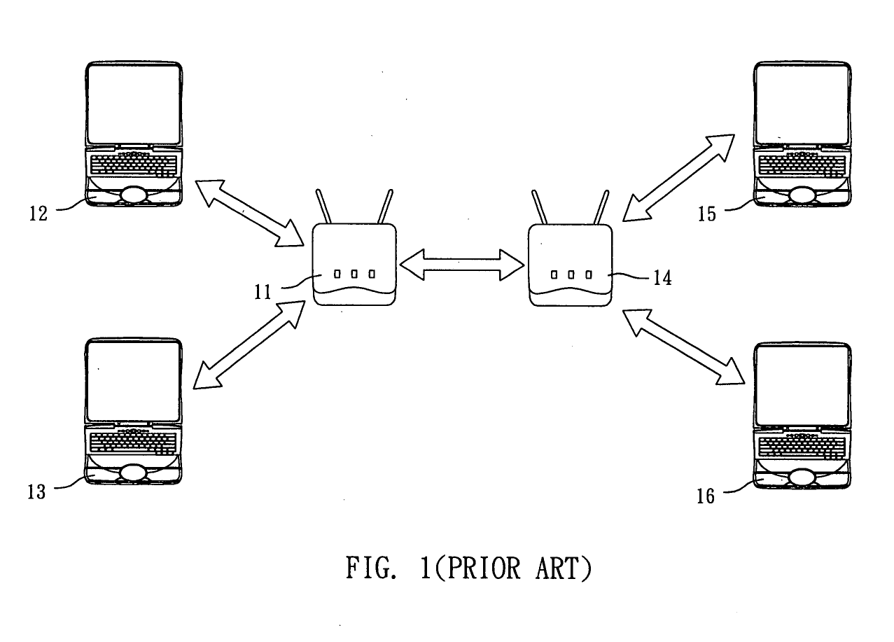

FIG. 2 is a schematic illustration showing wireless communication performed in a conventional peer-to-peer mode;

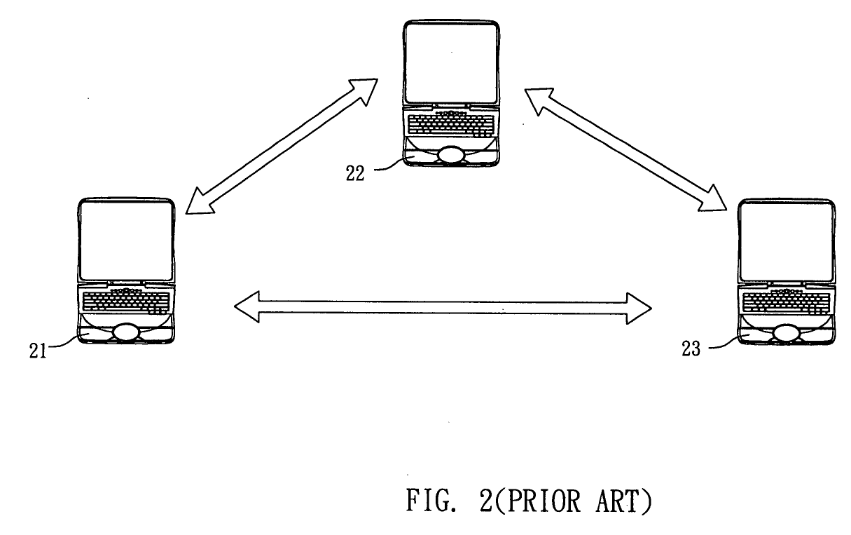

FIG. 3 is a block diagram showing a wireless bridge device according to a first embodiment of the invention;

FIG. 4 is a schematic illustration showing a wireless communication system according to a second embodiment of the invention;

FIG. 5 is a flow chart showing a wireless communication method according to a third embodiment of the invention;

FIG. 6 is another flow chart showing the wireless communication method according to the third embodiment of the invention;

FIG. 7 is a block diagram showing the wireless communication system according to the preferred embodiment of the invention; and

FIG. 8 is another schematic illustration showing the wireless communication system according to the preferred embodiment of the invention.

### DETAILED DESCRIPTION OF THE INVENTION

The present invention will be apparent from the following detailed description, which proceeds with reference to the accompanying drawings, wherein the same references relate to the same elements.

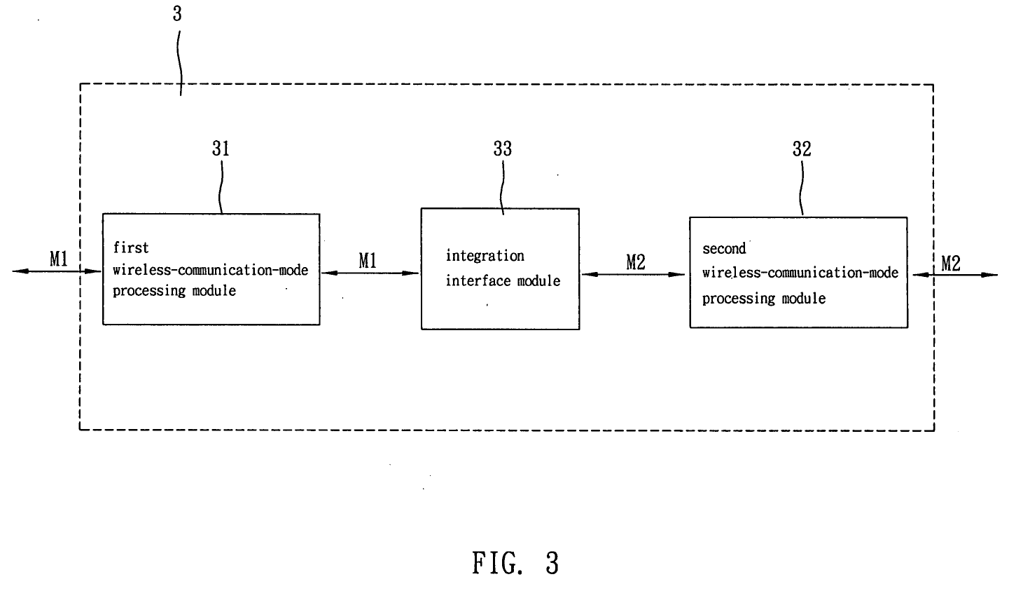

Referring to FIG. 3, a wireless bridge device 3 of the invention includes a first wireless-communication-mode processing module 31, a second wireless-communication-mode processing module 32 and an integration interface module 33. The first wireless-communication-mode processing module 31 receives or transmits a first wireless-communication-mode signal M1 in a first wireless communication mode. The second wireless-communication-mode processing module 32 receives or transmits a second wireless-communication-mode signal M2 in a second wireless communication mode. The first wireless communication mode may be the peer-to-peer mode or the access point mode, while the second wireless communication mode also may be the peer-to-peer mode or the access point mode. In this embodiment, the first wireless communication mode is the access point mode and the second wireless communication mode is the peer-to-peer mode.

The integration interface module 33 transforms the first wireless-communication-mode signal M1 into the second wireless-communication-mode signal M2, and transforms the second wireless-communication-mode signal M2 into the first wireless-communication-mode signal M1. In this embodiment, when the wireless local area network bridged to the wireless bridge device 3 works simultaneously in the first wireless communication mode and the second wireless communication mode, the first wireless-communication-mode processing module 31 and the second wireless-communication-mode processing module 32 work simultaneously. In addition, when the wireless local area network bridged to the wireless bridge device 3 only works in the first wireless communication mode or the second wireless communication mode, the first wireless-communication-mode processing module 31 and the second wireless-communication-mode processing module 32 do not have to work simultaneously. In other words, the first wireless-communication-mode processing module 31 and the second wireless-communication-mode processing module 32 may individually execute the wireless communication, or simultaneously execute the wireless communication through the integration interface module 33.

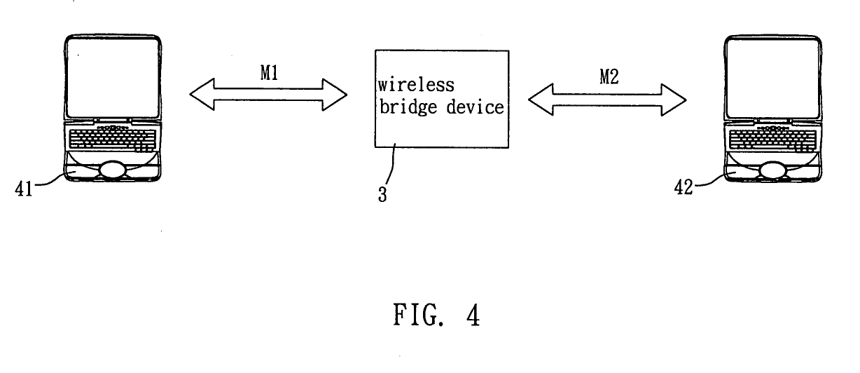

Referring to FIG. 4, a wireless communication system 4 according to the second embodiment of the invention includes a first electronic device 41, a second electronic device 42 and a wireless bridge device 3. The wireless bridge device 3 has been described in the first embodiment, and detailed descriptions thereof will be omitted. Herein, the wireless bridge device 3 also has a first wireless-communication-mode processing module (not shown), a second wireless-communication-mode processing module (not shown) and an integration interface module (not shown). The first wireless-communication-mode processing module receives or transmits a first wireless-communication-mode signal M1 in a first wireless communication mode. The second wireless-communication-mode processing module receives or transmits a second wireless-communication-mode signal M2 in a second wireless communication mode. The integration interface module transforms the first wireless-communication-mode signal M1 into the second wireless-communication-mode signal M2 and transforms the second wireless-communication-mode signal M2 into the first wireless-communication-mode signal M1.

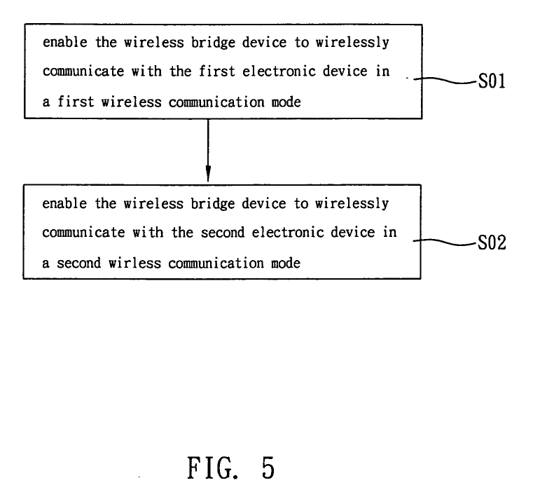

Referring to FIGS. 4 and 5, the wireless communication method of the third embodiment includes the following steps. Step S01 enables the wireless bridge device 3 to wirelessly communicate with the first electronic device 41 in a first wireless communication mode. Step S02 enables the wireless bridge device 3 to wirelessly communicate with the second electronic device 42 in a second wireless communication mode.

As shown in FIGS. 3 to 5, the first electronic device 41 emits the first wireless-communication-mode signal M1 to the wireless bridge device 3, or the wireless bridge device 3 emits the first wireless-communication-mode signal M1 to the first electronic device 41 in step S01, so as to establish the wireless communication between the wireless bridge device 3 and the first electronic device 41 in the first wireless communication mode. In step S02, the second electronic device 42 emits the second wireless-communication-mode signal M2 to the wireless bridge device 3, or the wireless bridge device 3 emits the second wireless-communication-mode signal M2 to the second electronic device 42 so as to establish the wireless communication between the wireless bridge device 3 and the second electronic device 42 in the second wireless communication mode. The first wireless-communication-mode signal M1 and the second wireless-communication-mode signal M2 may be respectively received and transmitted by the first wireless-communication-mode processing module 31 and the second wireless-communication-mode processing module 32 of the wireless bridge device 3, and may be transformed by the integration interface module 33. Consequently, the first electronic device 41 and the second electronic device 42 may communicate with each other through the wireless bridge device 3.

In this embodiment, the first electronic device 41 and the second electronic device 42 may be active electronic apparatuses or passive electronic apparatuses. Herein, the active electronic apparatus, such as a notebook computer, a mobile phone, a personal digital assistant (PDA), or the like having the wireless network function, may receive and transmit signals. The passive electronic apparatus is, for example, a wireless speaker, a wireless amplifier, a wireless television, or the like capable of receiving signals.

The wireless communication system 4 and the wireless communication method of the invention will be further described by taking the first electronic device 41 as an active electronic device.

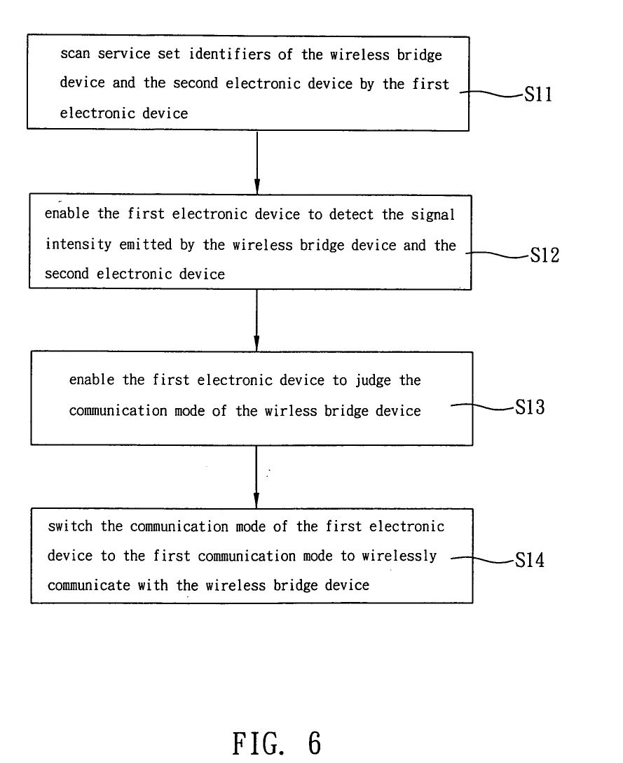

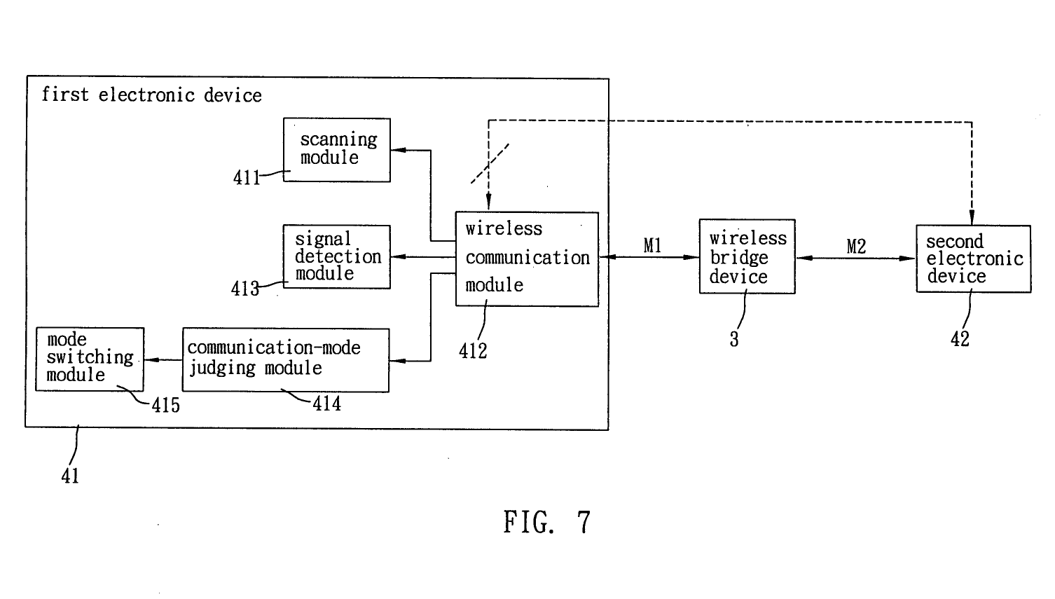

As shown in FIGS. 6 and 7, the detailed steps of the wireless communication method according to the third embodiment of the invention will be further described.

Step S11 scans service set identifiers of the wireless bridge device 3 and the second electronic device 42 by the first electronic device 41. In this embodiment, the service set identifiers of the wireless bridge device 3 and the second electronic device 42 are scanned by a scanning module 411 of the first electronic device 41. In practice, the received signals are transmitted to the scanning module 411 by a wireless communication module 412 of the first electronic device 41. The first electronic device 41, the wireless bridge device 3 and the second electronic device 42 have the same service set identifier. Because the same service set identifier represents the same wireless local area network, it is necessary to identify whether the service set identifiers are the same and then to decide whether the communication has to be made.

Step S12 enables the first electronic device 41 to detect the signal intensity emitted by the wireless bridge device 3 and the second electronic device 42. In this embodiment, a signal detection module 413 of the first electronic device 41 detects the signal intensity emitted by the wireless bridge device 3 and the second electronic device 42. When the signal intensity of the wireless bridge device 3 is greater than the signal intensity of the second electronic device 42, or the signal intensity of the second electronic device 42 is too low to communicate with the first electronic device 41, the communication between the first electronic device 41 and the wireless bridge device 3 is established.

When the signal intensity emitted by the wireless bridge device 3 is greater than the signal intensity emitted by the second electronic device 42, step S13 for enabling the first electronic device 41 to judge the communication mode of the wireless bridge device 3 is performed. In this embodiment, a communication-mode judging module 414 of the first electronic device 41 is used to judge the communication mode of the wireless bridge device 3. Herein, the communication-mode judging module 414 judges that the communication of the wireless bridge device 3 pertains to the first wireless communication mode.

Step S14 switches the communication mode of the first electronic device 41 to the first communication mode to wirelessly communicate with the wireless bridge device 3. In this embodiment, a mode switching module 415 of the first electronic device 41 switches the communication mode of the first electronic device 41 to the first wireless communication mode so as to communicate with the bridge device 3. At this time, the second electronic device 42 communicates with the wireless bridge device 3 in the second communication mode.

In this embodiment, the communication cannot be established because the distance from the second electronic device 42 to the first electronic device 41 is too long. However, the wireless bridge device 3 interconnects the first electronic device 41 with the second electronic device 42 such that the first electronic device 41 and the second electronic device 42 can communicate with each other.

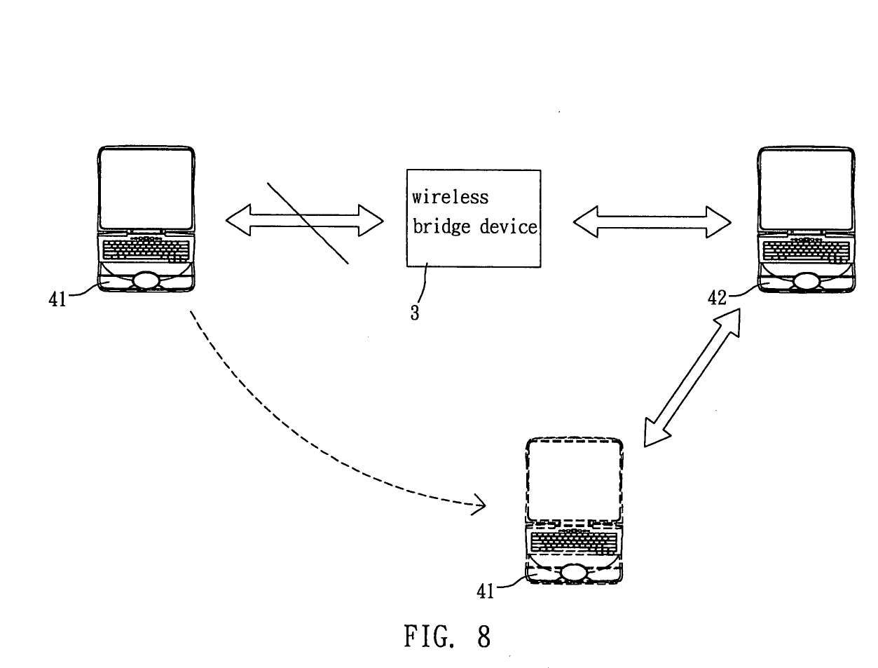

As shown in FIG. 8, when the first electronic device 41 is moved by a distance to a new location, as shown by the dashed line, and detects that the signal intensity of the second electronic device 42 is greater than the signal intensity of the wireless bridge device 3, or the signal intensity of the second electronic device 42 is sufficient to establish the communication, the first electronic device 41 terminates the wireless communication with the wireless bridge device 3. Then, the first electronic device 41 judges the communication mode of the second electronic device 42. Finally, the communication mode of the first electronic device 41 is switched to the second communication mode to wirelessly communicate with the second electronic device 42.

In summary, regarding to the wireless bridge device, the wireless communication system and the wireless communication method of the invention, the wireless bridge device may serve as a repeater device to lengthen the communication distance of the electronic device when the electronic devices perform the communication with the same mode. (e.g., the peer-to-peer mode). When the electronic devices perform the communication with different wireless communication modes, the wireless bridge device transforms the signals with different wireless communication modes to serve as a communication bridge for the electronic devices such that the information can be transmitted between the electronic devices.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A wireless communication method applying a wireless bridge device cooperating with a first electronic device and a second electronic device, the wireless communication method comprising the steps of:
scanning service set identifiers of the wireless bridge device and the second electronic device by the first electronic device;
detecting signal intensity emitted by the wireless bridge device and the second electronic device by the first electronic device;
wirelessly communicating with the first electronic device in a first wireless communication mode by the wireless bridge device; and
wirelessly communicating with the second electronic device in a second wireless communication mode by the wireless bridge device.

2. The method according to claim 1, wherein the first wireless communication mode is a peer-to-peer mode or an access point mode, and the second wireless communication mode is a peer-to-peer mode or an access point mode.

3. The method according to claim 1, further comprising, when the signal intensity emitted by the wireless bridge device is larger than the signal intensity emitted by the second electronic device, the step of:
enabling the first electronic device to judge a communication mode of the wireless bridge device; and
switching the communication mode of the first electronic device to the first wireless communication mode to wirelessly communicate with the wireless bridge device.

4. The method according to claim 1, further comprising, when the signal intensity emitted by the second electronic device is greater than the signal intensity emitted by the wireless bridge device, the step of:
enabling the first electronic device to stop wireless communication with the wireless bridge device.

5. The method according to claim 4, further comprising the step of:
enabling the first electronic device to judge a communication mode of the second electronic device.

6. The method according to claim 5, further comprising the step of:
switching the communication mode of the first electronic device to the second wireless communication mode to wirelessly communicate with the second electronic device.

7. A wireless bridge device, comprising:
a first wireless-communication-mode processing module for receiving and transmitting a first wireless-communication-mode signal in a first wireless communication mode;
a second wireless-communication-mode processing module for receiving and transmitting a second wireless-communication-mode signal in a second wireless communication mode; and
an integration interface module for transforming the first wireless-communication -mode signal into the second wireless-communication-mode signal and transforming the second wireless-communication-mode signal into the first wireless-communication-mode signal.

8. The device according to claim 7, wherein the first wireless-communication-mode processing module and the second wireless-communication-mode processing module work simultaneously.

9. The device according to claim 7, wherein the first wireless communication mode is a peer-to-peer mode or an access point mode, and the second wireless communication mode is a peer-to-peer mode or an access point mode.

10. The device according to claim 7, wherein the first wireless-communication-mode signal is emitted from a first electronic device or the integration interface module, and the second wireless-communication-mode signal is emitted from a second electronic device or the integration interface module.

11. A wireless communication system, comprising:
a wireless bridge device;
a first electronic device wirelessly communicating with the wireless bridge device in a first wireless communication mode; and
a second electronic device wirelessly communicating with the wireless bridge device in a second wireless communication mode.

12. The system according to claim 11, wherein the wireless bridge device comprises:
a first wireless-communication-mode processing module for receiving and transmitting a first wireless-communication-mode signal in a first wireless communication mode;
a second wireless-communication-mode processing module for receiving and transmitting a second wireless-communication-mode signal in a second wireless communication mode; and
an integration interface module for transforming the first wireless-communication-mode signal into the second wireless-communication-mode signal and transforming the second wireless-communication-mode signal into the first wireless-communication-mode signal.

13. The system according to claim 12, wherein the first wireless-communication-mode processing module and the second wireless-communication-mode processing module work simultaneously.

14. The system according to claim 11, wherein the first wireless communication mode is a peer-to-peer mode or an access point mode, and the second wireless communication mode is a peer-to-peer mode or an access point mode.

15. The system according to claim 11, wherein the first electronic device, the wireless bridge device, and the second electronic device have the same service set identifier.

16. The system according to claim 11, wherein the first electronic device comprises a scanning module for scanning the service set identifiers of the wireless bridge device and the second electronic device.

17. The system according to claim 11, wherein the first electronic device comprises a signal detection module for detecting signal intensity emitted by the wireless bridge device and the second electronic device.

18. The system according to claim 11, wherein the first electronic device comprises a communication-mode judging module for judging a communication mode of the second electronic device.

19. The system according to claim 11, wherein the first electronic device comprises a mode switching module for switching the communication mode of the first electronic device to the first wireless communication mode or the second wireless communication mode.
